(19) United States
(12) Patent Application Publication
(10) Pub. No.: US 2022/0391615 A1
(43) Pub. Date: Dec. 8, 2022

(54) TOOL FOR COUNTING AND SIZING PLANTS IN A FIELD

(71) Applicant: Hummingbird Technologies Limited, London (GB)

(72) Inventors: Mélissande Machefer, London (GB); François Lemarchand, London (GB); Virginie Bonnefond, London (GB); Alasdair Hitchins, London (GB); Panagiotis Sidiropoulos, Royston (GB)

(21) Appl. No.: 17/476,247

(22) Filed: Sep. 15, 2021

(30) Foreign Application Priority Data
Jun. 1, 2021 (GB) 2107816.7

(51) Int. Cl. G06K 9/00; G06T 7/00; G06T 7/11; G06T 7/194; G06T 5/20; G06K 9/62; G06K 9/32; G06K 9/66

(52) U.S. Cl. CPC G06K 9/00657; G06T 7/0004; G06T 7/11; G06T 7/194; G06T 5/20; G06K 9/6203; G06K 9/3233; G06K 9/66; G06T 2207/10032; G06T 2207/20084; G06T 2207/20081; G06T 2207/30188

(57) ABSTRACT

Aspects include methods and apparatuses generally relating to agricultural technology and artificial intelligence and, more particularly, to counting and sizing plants in a field. One aspect relates to a plants analysis apparatus for computer analysis of plants in an area of interest that generally includes an input device for receiving at least one aerial image of the area of interest; and an object-mask-predicting region-based convolutional neural network, Mask R-CNN, for performing object detection, wherein the Mask R-CNN is trained to detect a selected vegetable and to determine numbers and sizes of objects detected

### CROSS-REFERENCE TO RELATED APPLICATIONS

This application claims priority to foreign Great Britain patent application No. GB 2107816.7, filed on Jun. 1, 2021, the disclosure of which is incorporated by reference in its entirety.

### FIELD OF INVENTION

This invention relates to agricultural technology and artificial intelligence. More specifically, it relates to counting and sizing plants in a field.

### BACKGROUND

Fully Convolutional Networks (FCN) derive from models developed for classification purposes, by removing the last layer (used for classification), thus causing the network to learn feature maps instead of classes. This paradigm has been used for binary segmentation applications, in which the model learns pixel-level masks. For example an image could be classified into two classes where 0 would correspond to “not a plant” class, and 1 to “plant” class.

An issue with such simple solutions is that, since the spatial size of the final layer is generally reduced compared to the initial input size due to pooling operations within the network, the learned mask is a super-pixel one, i.e., a mask in which several pixels have been aggregated into one value. In order to recover the initial input spatial size, it has been suggested to combine high-resolution feature maps with skip connections and upsampling. In another line of research, Yu et al. “Multi-Scale Context Aggregation by Dilated Convolutions” (2015) and Chen et al. “DeepLab: Semantic Image Segmentation with Deep Convolutional Nets, Atrous Convolution, and Fully Connected CRFs” (2017) both propose to use a FCN supported by dilations (or dilated convolutions) to execute the necessary increase of receptive field.

In theory, a network achieving perfect accurate semantic segmentation could be straightforwardly used for instantiation (i.e., counting of blobs of one of the classes). However, in practice, this is a sub-optimal approach, since a model trained for segmentation would not discriminate between a false positive that erroneously joints two blobs (or a false negative that erroneously splits one blob) and a false positive (or negative) with no effect on the instantiation result. Hence, a number of deep learning techniques have been suggested to overcome this obstacle, by achieving simultaneously both semantic segmentation and instantiation. Two of these are YOLO and Mask R-CNN. The main difference between the two is that, while YOLO only estimates a bounding box of each instance (blob), Mask R-CNN goes further, by predicting an exact mask within the bounding box.

A precursor to Mask R-CNN is R-CNN, which was introduced in 2014 as a four-step object instantiation algorithm. The first step of this algorithm consists of a selective search which finds a fixed number of candidate regions possibly containing objects of interest. Next, the AlexNet model is applied to assess if the region is valid, before using a SVM to classify the objects to the set of valid classes. A linear regression concludes the framework to obtain tighter boxes coordinates, wrapping up the bounding box closer onto the object. R-CNN achieved a good accuracy, but the elaborate architecture caused a series of issues, mainly, a very high computational cost. Fast R-CNN, followed by Faster R-CNN, gradually overcame this limitation by turning it into an end-to-end fully trainable architecture, combining models and replacing the slow candidate selection step. Despite the progress, these R-CNN variations were limited on estimating object bounding boxes, i.e., they did not perform pixel-wise segmentation. Mask R-CNN enables pixel-wise segmentation by outputting masks as well as class labels and bounding box coordinates.

### SUMMARY OF THE INVENTION

A plants analysis apparatus for computer analysis of plants in an area of interest is provided. The apparatus comprises: an input device for receiving at least one aerial image of the area of interest; an object-mask-predicting region-based convolutional neural network (Mask R-CNN) for performing object detection, wherein the Mask R-CNN is trained to detect a selected vegetable and to determine numbers and sizes of objects detected.

Preferably, a mapping module is provided for dividing the area of interest into multiple cells and calculating, for each cell, an average size of objects in that cell, and an output device is provided for displaying results in the form of a map of the area of interest with at least one of colour and scale for each cell corresponding to the average size of objects in that cell.

Preferably, the output device shows which cells have vegetables falling in different average size categories. This enables a user to clearly see which areas of the field have vegetables that may be ready for harvesting and which areas will require more time.

Preferably, the map has a depth of colour or grayscale that progresses with vegetable size. This provides a user with an even clearer view of which areas of the field may require more or less attention.

A method for computer analysis of plants in an area of interest is provided. The method comprises: providing, from a camera, at least one aerial image of the area of interest; performing object detection using a computer adapted to perform as an object-mask-predicting region-based convolutional neural network (Mask R-CNN), wherein the Mask R-CNN is trained to detect a selected vegetable; and determining, using the computer adapted to perform as a Mask R-CNN, numbers and sizes of objects detected.

Preferably, the method further comprises dividing, by a mapping module, the area of interest into multiple cells.

Preferably, the method further comprises: calculating, by the mapping module, for each cell, an average size of objects in that cell; and displaying results in the form of a map of the area of interest with at least one of colour and scale for each cell corresponding to the average size of objects in the cell.

Preferably, the step of performing objection detection comprises performing object segmentation using a pixel-level binary classification. This is because most of the areas being imaged only comprise a single type of crop.

Preferably, the step of performing object detection comprises: generating feature maps, each feature map having a shape, the shape being a width in pixels of the feature map; providing predetermined anchor boxes, each pre-configured according to a corresponding feature map and each anchor box having a base width linked to the shape of its associated feature map; and applying a ratio to each anchor box to generate non-squared anchor boxes, wherein the anchor boxes are generated at each pixel of each feature map. This enables the algorithm to more accurately determine the likelihood of there being a particular vegetable in an image of a specific area.

Preferably, the anchor boxes are separated by a specific stride, the stride being a number of pixels that equates to a downscaling factor for the at least one aerial image.

Preferably, the method further comprises: comparing the anchor boxes with ground truth bounding boxes; determining an extent to which each anchor box matches with a ground truth bounding box; and selecting anchor boxes that match the most with the ground truth bounding boxes. This enables the best-matching anchor boxes to be selected, improving the accuracy later down the line.

Preferably, the step of determining the extent to which each anchor box matches with a ground truth bounding box comprises calculating an Intersection over Union (IoU) value, wherein: if the IoU value is lower than a first threshold the anchor is classified as negative; if the IoU value is between the first threshold and a second threshold the anchor is classed as neutral; and if the IoU value is greater than the second threshold the anchor is classed as positive. This ensures that the required anchor boxes can easily be separated from the non-required ones.

Preferably, a number of ground truth instances per image kept to train a region proposal network (RPN) is less than a third threshold. This helps to avoid training on images with too many objects to detect.

Preferably, the method further comprises carrying out a polygonal Non-Maximum Suppression (PNMS) algorithm to remove predicted selected anchor boxes overlapping with each other. This means that if multiple boxes overlap by too large a margin, only one needs to be processed.

Preferably, different model parameters are fed into the Mask R-CNN algorithm depending on the type of selected vegetable. This simplifies training the model to a particular vegetable (i.e. requires less manual input data) and/or improves the accuracy for each type of vegetable.

Preferably, the Mask R-CNN algorithm comprises a detection layer that outputs regions of interest (ROIs). This enables a user to see where in the image the desired vegetables are.

Preferably, the Mask R-CNN algorithm outputs pixel-level masks for each vegetable in the area of interest. This enables pixel-wise segmentation.

Preferably, the at least one aerial image undergoes an orthomosaicking procedure performed by an orthomosaicking module, the orthomosaicking procedure comprising: determining, for a specific field, a percentage of the field that is covered by the at least one aerial image; and proceeding only if the percentage of the field covered by the at least one aerial image is above a threshold. This produces a map that is geometrically more accurate, which helps to generate more reliable results, and also ensures that time and resources are not wasted if not enough of the field has been covered to generate a useful output.

A method for computer analysis of plants in an area of interest is provided. The method comprises: providing, from a camera, at least one aerial image of the area of interest; performing object detection using a computer adapted to perform as an object-mask-predicting region-based convolutional neural network (Mask R-CNN), wherein the Mask R-CNN is trained to detect a selected vegetable; determining, using the computer adapted to perform as a Mask R-CNN, numbers and sizes of objects detected; dividing, by a mapping module the area of interest into multiple cells; and displaying, by a display module, results in the form of a map of the area of interest with at least one of colour and scale for each cell corresponding to an average size of objects in that cell, wherein the map shows which cells have vegetables falling in different average size categories.

Preferably, the map has a depth of colour or grayscale that progresses with vegetable size. This provides a user with an even clearer view of which areas of the field may require more or less attention.

Preferably, the method further comprises stitching together all the vegetable masks outputted by the Mask R-CNN algorithm. Vegetable masks are stitched together before statistical analysis in order to make sure that the output is correct.

Preferably, the method further comprises: determining whether the average size of the object in each cell is within a threshold; and additionally colouring the map to show which cells have objects whose average size is within the threshold. This enables a user to identify a threshold above or below which a chemical should be applied to vegetables within a cell, set the threshold and then easily be able to determine which cells require chemical application.

Preferably, each cell represents an area of 2×2 metres. This is a useful cell size for multiple types of vegetables, such as lettuce.

The map can display the size of each individual vegetable in the area of interest, but by representing the map in cells and providing only the average size (and, optionally, standard deviation) per cell, browsing of the output is faster and the user experience is better.

### BRIEF DESCRIPTION OF THE DRAWINGS

FIG. 1 is a flow diagram depicting a method of analysing plants in a field.

FIG. 2 is a flow diagram depicting a Mask R-CNN algorithm.

FIG. 3 is a flow diagram depicting an orthomosaicking procedure.

FIG. 4 is a flow diagram depicting a post-processing and output display procedure.

FIG. 5 is a diagram showing a gridded lettuce mask applied to a map of a field.

FIG. 6 is a flow diagram depicting a method of determining which cells to colour in a map of a field.

FIG. 7 is a diagram showing a computer system.

### DETAILED DESCRIPTION

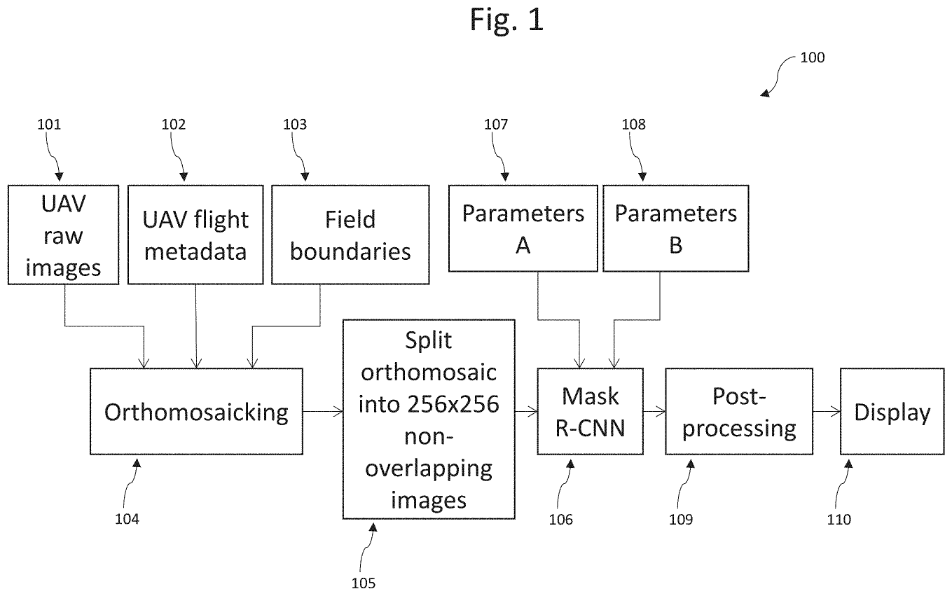

Referring to FIG. 1, a computer implemented program 100 for analysing plants is illustrated. UAV raw images 101 may be defined as at least one unprocessed aerial image of one or more fields obtained by an unmanned aerial vehicle (UAV) during a flight. UAV flight metadata 102 is geolocation and image quality metadata related to the flight of the UAV. Field boundaries 103 specify the geographic extent of each field imaged during the flight. Field boundaries are defined and stored offline before the first UAV flight of the one or more fields. One or more fields may be imaged during a single flight.

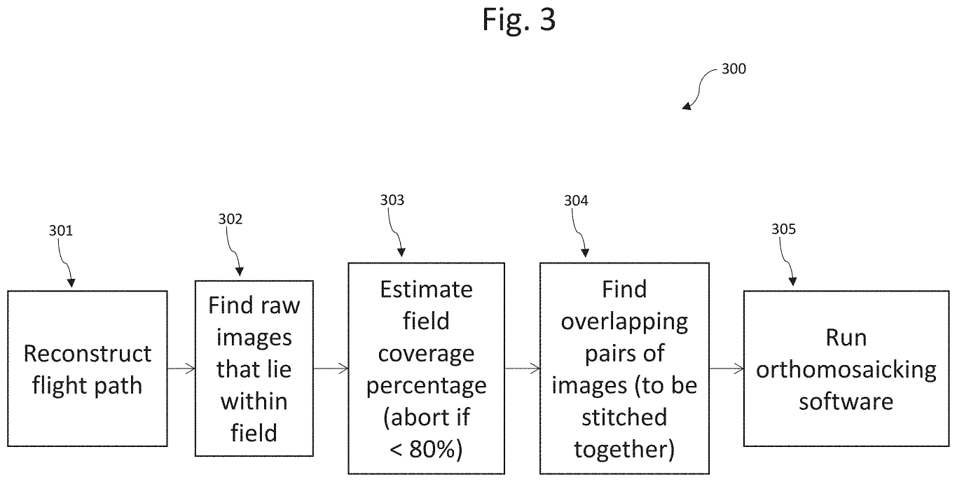

Orthomosaicking module 104 is a software module used to generate an orthomosaic, which is a geometrically accurate aerial image that is composed of many individual still images that are stitched together and orthorectified (geometrically transformed to produce a top-down area view). UAV raw images 101, UAV flight metadata 102 and field boundaries 103 are all inputs for the orthomosaicking module 104, which is described in greater detail in FIG. 3. An orthomosaic may be split 105 into a number of non-overlapping images.

Mask R-CNN 106 is a deep learning neural network that performs object instantiation in images. For a given image, Mask R-CNN 106 will return, for each object (in this case a vegetable of interest): (a) a class label identifying the object; (b) bounding box coordinates for the object; and (c) a pixel-level object mask. In particular, Mask R-CNN 106 firstly generates proposals about regions where there might be an object based on an input image. It then predicts the class of the object (e.g. vegetable of interest), refines the bounding box and generates a mask in pixel level of the object based on the first stage proposal.

Mask R-CNN 106 may be trained to detect a specific object. The specific object may be a vegetable, such as lettuce. The algorithm calculates the number of objects and the size of each object.

Parameters A 107 and parameters B 108 are sets of parameters that may feed into the Mask R-CNN algorithm 106. Each set of parameters may relate to a specific type of object to be detected (for example, these parameters may represent pre-trained Mask R-CNN models). Here, the two sets of parameters may relate to two different types of vegetable. Depending on which vegetable a user wishes to detect, one set of parameters may be inputted. Parameters A 107 may be parameters for lettuces and parameters B 108 may be parameters for broccoli. Although only two possible sets of parameters are shown in FIG. 1, alternative sets of parameters relating to other types of vegetable, such as celery, may also be fed into the algorithm.

There is no difference between the model parameters when training to identify and analyse lettuce, broccoli and celery, other than these are models trained on different datasets (so parameters A and B represent the different trained models). At a higher level, the model parameters themselves can be selected according to the vegetable on which the model is to be trained. For example, the parameters for a potatoes model may be different from those for lettuce, broccoli and celery, not least because potatoes have a greater size variation and, at maturity, they are a larger plant, so there will be fewer plants in a given 256×256 pixel image. Thus, image size and Bsₛ are examples of model parameters that might be selected according to the type of object to be detected.

Post-processing module 109 refers to a step of additional processing to a multi-dimensional object map image (2 dimensions plus object size and any other data) produced by the Mask R-CNN process. The post-processing 109 may be performed on the images outputted from the Mask R-CNN algorithm 106.

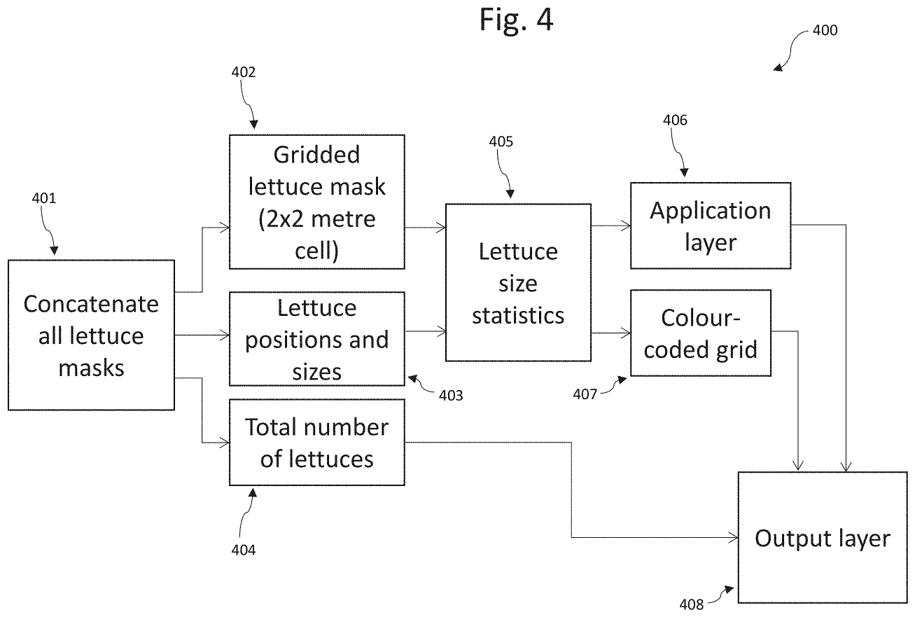

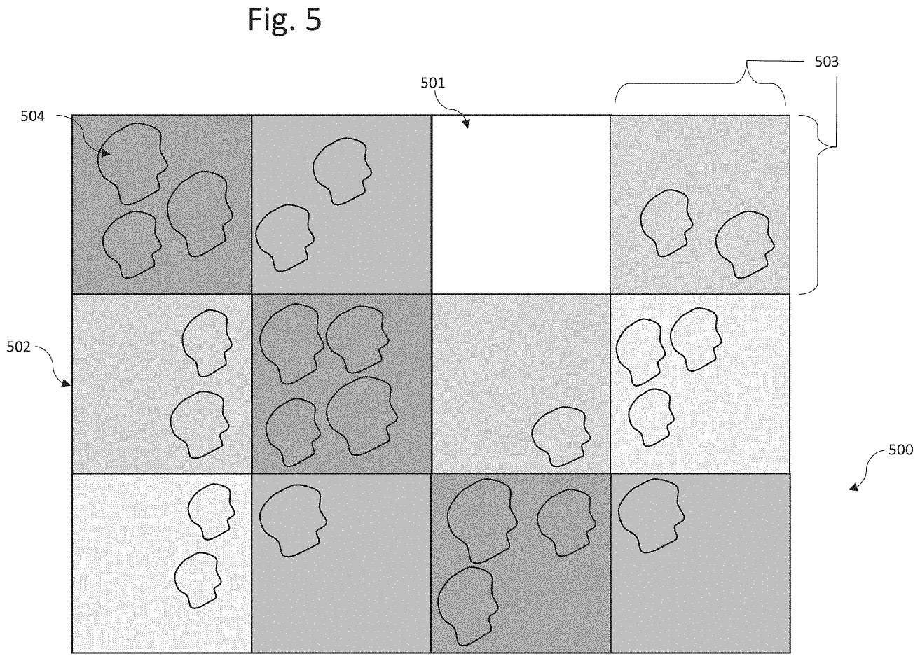

Display module 110 may display to a user the output of the post-processing module 109. The output may be in the form of a colour-coded map, as will be discussed in FIGS. 4 and 5.

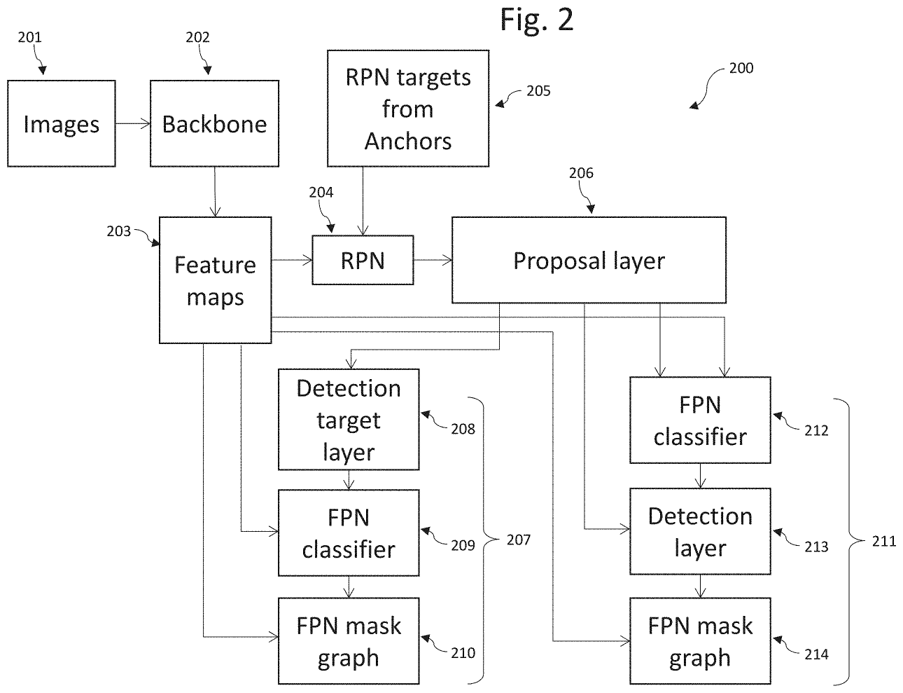

In operation, UAV raw images 101 and UAV flight metadata 102 are all taken from a single flight. Field boundaries 103 are usually defined offline, rather than during the flight. The resulting orthomosaic from the orthomosaicking module 104 is split 105 into non-overlapping images. The non-overlapping images may be 256×256 pixels. The Mask R-CNN algorithm 106 is then applied to the non-overlapping images. This algorithm is described in greater detail in FIG. 2. Parameters A 107 or parameters B 108 may be fed into the Mask R-CNN algorithm 16, depending on the type of vegetable that is being detected. Post-processing 109 may then be performed on the outputs of the Mask-R-CNN algorithm. The post-processing 109 is described in greater detail in FIG. 4. The output of the post-processing module 109 may be displayed through a display module 110.

In FIG. 1, each box is a module of computer code performed by a processor, having memory that stores parameters and training data.

The present deep learning model introduced to tackle the plant counting and sizing tasks is illustrated in FIG. 2 and is based on the Mask R-CNN architecture.

FIG. 2 illustrates the different blocks composing the Mask R-CNN 106.

Referring to FIG. 2, the images 201 are images to which the Mask R-CNN algorithm is applied. The images 201 may be RGB images and may be the non-overlapping images into which the orthomosaic is split into in block 105 of FIG. 1.

The backbone 202 is a network in charge of visual feature extraction at different scales. The backbone may be a pre-trained ResNet, which is a convolutional neural network. Different versions of ResNet may have different numbers of layers. In this case, a ResNet101, which has 101 layers, may be used, but the number of layers may range from 34 or fewer to 152 or more.

The feature maps 203 are mappings of where specific features are found in an image and are outputted from the backbone 202. More specifically, feature maps 203 are transformations of input data (in this case, images) in a high-dimensional space that has coded all the relevant information. In this way, a feature map 203 is a mathematical representation of the content of an image, prior to the extraction of any semantic information. For example, one feature map 203 may be a mapping of proposed regions where lettuces may be found in the image. In a feature map 203, each region may be a different size. Each feature map 203 has a shape, which is a width in pixels of the feature map.

The region proposal network (RPN) 204 is a fully convolutional network that simultaneously predicts object bounds and objectness scores at each position. In this way, the RPN 204 may propose a region in which a particular object lies. The RPN 204 may learn this from the feature maps 203 obtained from the backbone 202.

Anchor boxes are a set of predefined bounding boxes of a certain height and width which are defined to capture the scale and aspect ratio of specific object classes that a user may want to detect. These predetermined boxes are designed for each feature map with specific base scales linked to the feature map shapes, and a specific ratio is applied to them. Each anchor box may be pre-configured according to a corresponding feature map and each anchor box has a base scale (width in pixels) linked to the shape of its associated feature map. Anchor boxes may be generated at each pixel of each feature map and may be separated by a specific stride, the stride being a number of pixels that equates to a downscaling factor for the original images. Anchor boxes may be obtained by a sliding window method and may be generated at each pixel of each feature map with a specific stride. RPN targets 205 are extra inputs for the RPN 204 and may be generated from a collection of anchor boxes. The RPN targets 205 can therefore be used to help the RPN 204 propose regions of interest (ROIs).

An anchor box may be compared with a ground truth box to determine its accuracy. A ground truth box is provided based on empirical input. More specifically, a ground truth box is a rectangular bounding box from a testing set, which specifies where an object is in an image. Ground truth boxes are typically hand-drawn and are used for training the Mask R-CNN model.

The proposal layer 206 comprises a filtering block which only keeps relevant suggestions from the RPN 204. The RPN 204 feeds into the proposal layer 206. The proposal layer 206 outputs Regions of Interest (ROIs).

The training path 207 is a path that the Mask R-CNN may follow in order to train itself. The training path 207 comprises a detection target layer 208, an FPN classifier 209 and an FPN mask 210.

The detection target layer 208 is another filtering step for the ROIs from the proposal layer 206 and uses ground truth boxes to compute the overlap with the ROIs. The detection target layer 208 outputs ROIs with corresponding ground truth masks, instance classes, and ground truth box offsets for positive ROIs.

The FPN classifier 209 and the FPN mask graph 210 are both parts of a feature production network (FPN). An FPN is a feature extractor that takes a single-scale image of an arbitrary size as input, and outputs proportionally sized feature maps at multiple levels, in a fully convolutional fashion. The FPN classifier 209 classifies objects in the ROIs. Specifically, the FPN classifier 209 outputs a classifier head with logits and probabilities for each item of the collection to be an object and belong to a certain class as well as refined box coordinates.

The output of the FPN mask graph step 210 is a collection of masks of fixed squared size which may be re-sized to the shape in pixels of the corresponding bounding box extracted in the FPN classifier 209.

The inference path 211 is a path that the Mask R-CNN algorithm, once trained, may follow in order to make predictions. The inference path 211 comprises an FPN classifier 212, a detection layer 213, and an FPN mask 214. The FPN classifier 212 functions in the same way as the FPN classifier 209, but is directly applied to ROIs extracted from the proposal layer 206.

The detection layer 213 is a filter layer that filters proposals from the proposal layer based on probability scores per image per class extracted from the FPN Classifier 212. The most promising ROIs are outputted from the detection layer 213.

In the FPN mask graph 214 step, the ROIs outputted from the detection layer 213 have their masks extracted.

Thus, Mask R-CNN adds a FCN branch to the R-CNN architecture, which predicts a segmentation mask of each object. As a result, the classification and the segmentation parts of the algorithm are independently executed. Hence, the competition between classes does not influence the mask retrieval stage. Another important contribution of Mask R-CNN is the improvement of pixel accuracy by refining the necessary pooling operations obtained by bilinear interpolation (instead of rounding operation) with the so-called ROIAlign algorithm.

If the original Mask R-CNN model is trained on a large number of natural scene images with coarsely-annotated natural scenes as is (without modifications of the default parameters) and the model is applied to UAV images of plants, the results are poor. The main reason behind this failure is the large number of free parameters (around 40) in the Mask R-CNN algorithm, which are originally optimised for different uses (e.g. indoor images, surveillance etc.) to vegetable identification.

The preferred model parameters listed in Table 1 below. The variables names are taken from the known Matterport implementation described by Abdulla, W. Mask R-CNN for Object Detection and Instance Segmentation on Keras and TensorFlow [2017] and available online at: https://github.com/matterport/Mask_RCNN.

TABLE 1

| | VARIABLE NAME IN | | |
|---|---|---|---|
| | MATTERPORT | | PREFERRED |
| ACRONYM | IMPLEMENTATION | DESCRIPTION | VALUES |
| Bsₜ | BACKBONE_STRIDES | List of strides in | [4, 8, 16, 32, 64] |
| | | pixels of each | |
| | | convolution layer | |
| | | which generates | |
| | | the feature maps | |
| | | used from the | |
| | | Backbone | |
| Bsₛ | BACKBONE_SHAPE | List of width in | [64, 32, 16, 8, 4] |
| | | pixels of each | |
| | | squared feature | |
| | | map used to feed | |
| | | the RPN obtained | |
| | | from Bsₜ | |
| RPNasₛ | RPN_ANCHOR_SCALE | List of base | (8, 16, 24, 32, 48) |
| | | width in pixels of | |
| | | each anchor used | |
| | | for each feature | |
| | | map | |
| RPNasₜ | RPN_ANCHOR_STRIDE | Stride in pixels of | 2 |
| | | the locations of | |
| | | the anchors | |
| | | generated for | |
| | | each feature map | |
| RPNar | RPN_ANCHOR_RATIO | List of ratio to | [0.5, 1, 2] |
| | | apply on each | |
| | | element of | |
| | | RPNasₛ aiming | |
| | | at generating non | |
| | | squared anchors | |
| RPNtapi | RPN_TRAIN_ANCHORS_PER_IMAGE | Number of | 300 |
| | | anchors per | |
| | | image selected to | |
| | | train the RPN | |
| pNMSl | PRE_NMS_LIMIT | Number of kept | 6000 |
| | | proposals | |
| | | outputted by the | |
| | | RPN based on | |
| | | their RPN scores | |
| RPN_NMSt | RPN_NMS_THRESHOLD | IoU threshold for | 0.7 |
| | | stating | |
| | | overlapping RPN | |
| | | predicted boxes | |
| pNMSrₜᵣ | POST_NMS_ROIS_TRAINING | Number of ROIs | 1800 |
| | | to keep after | |
| | | NMS in the | |
| | | Proposal Layer | |
| | | for the training | |
| | | phase | |
| pNMSr_{inf} | POST_NMS_ROIS_INFERENCE | Number of ROIs | 1100 |
| | | to keep after | |
| | | NMS in the | |
| | | Proposal Layer | |
| | | for the inference | |
| | | phase | |
| mGTi | MAX_GROUNDTRUTH_INSTANCES | Number of | 300 |
| | | ground truth | |
| | | instances per | |
| | | image kept to | |
| | | train the network | |
| trROIpi | TRAIN_ROI_PER_IMAGE | Number of ROIs | 300 |
| | | to keep after the | |
| | | Detection Target | |
| | | Layer | |
| ROIpr | ROI_POSITVE_RATIO | Ratio of positive | 0.33 |
| | | ROIs among the | |
| | | trROIpi | |
| Dmi | DETECTION_MAX_INSTANCES | Maximal number | 300 |
| | | of instances that | |
| | | the Mask R-CNN | |
| | | is allowed to | |
| | | output per image | |
| | | in the prediction | |
| | | mode. It also | |
| | | corresponds to | |
| | | the number of | |
| | | ROIs outputted | |
| | | by the Detection | |
| | | Layer | |
| Dmc | DETECTION_MIN_CONFIDENCE | Minimum FPN | 0.7 |
| | | Classifier | |
| | | probability for an | |
| | | ROI to be | |
| | | considered as | |
| | | containing an | |
| | | object of interest | |
| DNMSt | DETECTION_NMS_THRESHOLD | NMS threshold | 0.5 |
| | | used in the | |
| | | Detection Layer | |

By following the terminology and architecture of Table 1, the goal is to unfold the parameters' tuning process to ensure a fast and accurate individual plant segmentation and detection output while facilitating reproducibility.

The use of Mask R-CNN in the examined setup presents several challenges, related to the special characteristics of high-resolution remote sensing images of agriculture fields.

Firstly, most of the fields have a single crop, so the classification branch of the pipeline is a binary classification algorithm, a parameter which affects the employed loss function. Secondly, the remotely sensed images of plants impose the target objects (i.e., plants) to not present the same features, scales, and spatial distribution as natural scene objects (e.g., humans, cars) included in other datasets used for the Mask R-CNN model training Thirdly, the main challenges of this setup are different than many natural scene ones. For example, false positives due to cluttered background (a main source of concern in multiple computer vision detection algorithms) is expected to be rather rare in plant counting/sizing setup, while object shadows affect the accuracy more than in several computer vision applications. Due to these differences, Mask R-CNN parameters need to be carefully fine-tuned to achieve an optimal performance.

The input images 201 are fed into the Backbone 202 network in charge of visual feature extraction at different scales. The Backbone may be a pre-trained ResNet-101. Each block in the ResNet architecture outputs a feature map 203 and the resulting collection of feature maps 203 is served as an input to different blocks of the architecture: the Region Proposal Network (RPN) 204 but also the Feature Pyramid Network (FPN). By setting the backbone strides Bsₜ, the sizes of the feature maps Bsₛ which feed into the RPN 204 can be chosen, as the stride controls downscaling between layers within the backbone. The importance of this parameter lies in the role of the RPN 204. For example, Bsₜ=[4, 8, 16, 32, 64] induces Bsₛ=[64, 32, 16, 8, 4] (all units in pixels) if the input image size is squared of width 256 pixels. The RPN targets 205 generated from a collection of anchor boxes form an extra input for the RPN 204. These predetermined boxes are designed for each feature map with base scales RPNasₛ linked to the feature map shapes Bsₛ, and a collection of ratios RPNar is applied to these RPNasₛ. Finally, anchors are generated at each pixel of each feature map 203 with a stride of RPNasₜ. In total, with Rₗ the number of RPN anchors ratios introduced, the total number of anchors generated, nbₐ, is defined as:

$${nb}_{a} = {\sum }_{i} {int ( \frac{{Bs}_{s} [ i ]}{{RPNas}_{t}} )}^{2} \times {R}_{l}$$

All the coordinates are computed in the original input image pixel coordinates system. Not all of the nbₐ anchors contain an object of interest, so only the anchors matching the most with the ground truth bounding boxes filters will be selected. The extent to which an anchor matches a ground truth bounding box filter is determined by computing the Intersection Over Union (IoU) between anchor boxes and ground truth bounding boxes locations. The IoU is defined as follows:

$$IoU = \frac{Area of overlap}{Area of union}$$

Here, the area of overlap relates to the area in which the anchor box overlaps with the ground truth bounding box. The area of union relates to the area covered by the two boxes.

If IoU>0.7, then the anchor is classified as positive. If 0.3<IoU≤0.7, the anchor is classified as neutral. If IoU≤0.3, the anchor is classified as negative. Then, the collection is resampled to ensure that the number of positive and negative anchors is greater than half of RPNtapi, which is a share of the total nbₐ anchors kept to train the RPN 204.

Eventually, the RPN targets 205 have two components for each image: a vector which states if each of the nbₐ anchors is positive, neutral or negative, and the second component which is represented by delta coordinates between ground truth boxes and positive anchors among the RPNtapi selected anchors to train the RPN 204. Only mGTi ground truth instances are kept per image to avoid training on images with too many objects to detect. This parameter is important for training on natural scene images composing the COCO dataset as they might contain an overwhelming number of overlapping objects.

Dimensions of the targets for one image are [nbₐ] and [RPNtapi, (dy, dx, log log (dh), log log (dw))], where dy and dx are the normalised distance of the coordinates centers between ground truth and anchor boxes, whereas log log (dh) and log log (dw) respectively deal with the logarithm delta between height and width. Finally, the RPN 204 is a FCN aiming at predicting these targets.

The RPN 204 feeds into the Proposal Layer 206. The Proposal Layer 206 does not consist of a network, but a filtering block which only keeps relevant suggestions from the RPN 204. As already stated, the RPN 204 produces scores for each of the nbₐanchors with the probability to be characterised as positive, neutral or negative and the Proposal Layer 206 begins by keeping the highest scores to select the best pNMSl anchors. Predicted delta coordinates from the RPN 204 are coupled to the selected pNMSl anchors. Then, a polygonal Non-Maximum Suppression (PNMS) algorithm is carried out to prune away predicted RPN boxes overlapping with each other. If two boxes among the pNMSl have more than RPN_NMSt overlap, the box with the lowest score is discarded. Finally, the top pNMSrₜᵣ for the training phase and pNMSr_{inf} for the inference phase are kept based on their RPN score. At this stage, the training path 207 and the inference path 211 diverge, despite the inference path 211 relying on blocks previously trained.

After the Proposal Layer 206, the training path 207 begins with the Detection Target Layer 208. The Detection Target Layer 207 is not a network, but another filtering step for the pNMSrₜᵣ ROIs outputted by the Proposal Layer 206. The Detection Target Layer 207 uses the mGTi ground truth boxes to compute the overlap with the ROIs and set them as a boolean based on the condition IoU >0.5. Finally, these pNMSrₜᵣ ROIs are subsampled to a collection of trROIpi ROIs but randomly resampled to ensure a ratio ROIpr of the total trROIpi as positive ROIs. As the link with ground truth boxes is established in this block and the notion of anchors is dropped, the output of the Detection Target Layer 208 is composed of trROIpi ROIs with corresponding ground truth masks, instance classes, and ground truth box offsets for positive ROIs. The ground truth boxes are padded with 0 values for the elements corresponding to negative ROIs. These generated ground truth features corresponding to the introduced ROIs features will serve as ground truth to train the FPN.

In the training path 207, the Feature Pyramid Network (FPN) is composed of the FPN Classifier 209 and the FPN Mask Graph 210. The input to these layers are ROIs, which are a collection of regions with their corresponding pixel coordinates. The nature of these ROIs can vary during the training and inference phase as shown in FIG. 3. Both of the extensions of the FPN (Classifier and Mask) present the same succession of blocks, composed of a sequence of ROIAlign and convolution layers with varying goals. The ROIAlign algorithm, as stated in the beginning of this section, has to pool all feature maps from FPN lying within the ROIs by discretising them into a set of fixed square pooled size bins without generating a pixel misalignment unlike traditional pooling operations. After ROIAlign is applied, the input of the convolution layers is a collection of same size squared feature maps, and the size of the batch is the number of ROIs. In the case of the FPN Classifier 209, the output of these deep layers is composed of a classifier head with logits and probabilities for each item of the collection to be an object and belong to a certain class as well as refined box coordinates which should be as close as possible from the ground truth boxes used at this step. In the case of the FPN Mask graph 210, the output of this step is a collection of masks of fixed squared size which will later on be re-sized to the shape in pixels of the corresponding bounding box extracted in the classifier. It has been explained that, for the training phase, the Detection Target Layer 208 outputs trROIpi ROIs and computes corresponding ground truth boxes, class instances, and masks which are used for the training of a sequence of FPN Classifier 209 and FPN Mask Graph 210 as shown in FIG. 2.

For the inference path 211, the trained FPN is used in prediction, but the FPN Classifier 212 is firstly applied to the pNMSr_{inf} ROIs extracted from the Proposal Layer 206, followed by a Detection Layer 213. It ensures the optimal choice of ROIs to only keep Dmi ROIs. Finally, these masks are extracted by the final FPN Mask Graph 214 in prediction mode.

The Detection Layer block 213 is dedicated to filtering the pNMSr_{inf} proposals coming out from the Proposal Layer 206 based on probability scores per image per class extracted from the FPN Classifier Graph 212 in inference mode. ROIs with low probability scores under Dmc are discarded, and NMS is applied to remove lowest score ROIs overlapping more than DNMSt with a higher score. Finally, only the best Dmi ROIs are selected to extract their masks with the FPN Mask Graph 214. Each of these blocks is trained with a respective loss in regard to the nature of its function. Boxes' coordinates prediction is associated with a smooth L1-loss, binary mask segmentation with binary cross-entropy loss, and instance classification with categorical cross-entropy loss. The known Adam optimiser is used to minimize these loss functions.

The dataset size is a significant factor for a successful model. In the past, accurate labeling of 10 K images per class has been considered necessary to obtain satisfactory results on instance segmentation tasks with natural scene images. At a resolution between 1.5 cm and 2 cm, digitising 150 masks of a low density crop takes around an hour for a trained annotator. As a result, precise pixel labeling of 10 K images implies a significant amount of person-hour.

However, pre-training a CNN on a large coarsely-annotated dataset, such as the COCO dataset (200 K labeled images) for natural scene images, and fine-tuning on a smaller refined dataset of the same nature leads to better performances than training directly on a larger finely-annotated dataset. Consequently, transferring the learning from the large and coarse COCO dataset to coarse and refined smaller plant datasets makes the complex Mask R-CNN architecture portable to the new plant population task.

The parametrization setup of the Mask R-CNN model is key to facilitating the training of the model and maximizing the number of correctly detected plants. It was observed that the default parameters in the original implementation of Matterport would lead to poor results due to an excessive amount of false negatives. Therefore, an extensive manual search guided by understanding the complex parameterization process of Mask R-CNN is necessary. Mask R-CNN is originally trained on the COCO dataset which is composed of objects of highly varying scales that can sometimes fully overlap between each other (leading to the presence of the so-called crowd boxes). Most of the objects of interest have a smaller range of scales, and two plants cannot have fully overlapping bounding boxes.

Regarding the scale of both lettuce and broccoli crops, an individual plant goes from 4 to 64 pixels at the selected resolutions. Based on these observations, optimising the selection of the ROIs through the RPN and the Proposal Layer can be solved by tuning the size of the feature maps Bsₛ and the scale of the anchors RPNasₛ. Bsₜ cannot be modified due to the Backbone being pre-trained on COCO weights and the corresponding layers frozen.

The pixel size of 256×256 was chosen to include sizes of feature maps corresponding to the range of scales of the plant “objects”.

Taking into account the imagery resolution and an estimation of the range of the plant drilling distance, mGTi can easily be inferred. It is estimated that not more than mGTi=300 lettuces could be found in an image of 256×256 pixels. This observation also allows for setting the number of anchors per image RPNtapi to train the RPN and the number of trROIpi in the Detection Target layer to be set to the same value. Starting from this known estimation of the maximum number of expected plants, this bottom-up view of the architecture is key to finding a more accurate number of ROIs to keep at each block and phase for each of the crops investigated. The parameters involved are pNMSrₜᵣ and pNMSr_{inf}. Thresholds used for IoU in the NMS (RPN_NMSt, DNMSt) and confidence scores (Dmc) can also be tuned but the default values were kept due to tuning attempts being inconclusive.

Referring now to FIG. 3, an orthomosaicking process 300 is described. The orthomosaicking process 300 may be performed by orthomosaicking module 104 of FIG. 1. Starting at block 301, the flight path of the UAV is reconstructed. This may be performed using the UAV flight metadata 102 from FIG. 1. At 302, any raw images that lie within a particular field or fields are found. The raw images may be the UAV raw images 101 and the field boundaries 103 may be used to determine whether the raw images lie within a particular field or fields.

At 303, the field coverage percentage is estimated. Specifically, for a given field, the percentage of the total field area that is covered by the raw images is estimated. If the field coverage percentage is less than 80 percent, the process is aborted. If the field coverage percentage is greater than or equal to 80 percent, the process continues to step 304.

At step 304, any overlapping pairs of images are determined. These pairs of images will be stitched together.

At step 305, the orthomosaicking software is run.

Referring now to FIG. 4, details of the post-processing module 109 and display module 110 of FIG. 1 is shown. At step 401, object masks (i.e. masks corresponding to vegetables such as lettuces or potatoes) are concatenated. Specifically, the masks are stitched together to form one mask showing all the lettuces in the area covered by the original image. The masks may be the masks outputted from the Mask R-CNN algorithm 106, as described in FIG. 2.

It is to be noted that although FIG. 4 and the following paragraphs refer to a post-processing procedure for lettuce masks, the same procedure may be applied to broccoli, celery or another type of vegetable.

Once the lettuce masks have been concatenated, three processes can be performed: a gridded lettuce mask process 402, lettuce positioning and size measuring process 403 and a summation process to give the total number of lettuces 404.

The gridded lettuce mask process 402 divides the concatenated mask image output from the Mask R-CNN into a grid with cells of a desired size, and applies the grid to an image of a desired area. The grid is preferably a grid of 2 m×2 m cells, but the cells could be larger or smaller. A grid of 1 m×1 m represents a lower useful cell size for lettuces. A larger size may be used for larger vegetables such as potatoes. The cell size could be 4 m×4 m or 5 m×5 m. The size of the cells can be set by a user. The grid can be a hexagonal grid with cells of equivalent size. The desired area may be one or more fields, for example the one or more fields on which the UAV raw images 101 are based.

The lettuce positions and sizes 403 represent the locations of each lettuce in a field and the size of each individual lettuce. The total number of lettuces 404 represents the number of lettuces across the entire image.

Lettuce size statistics 405 are obtained from the gridded lettuce mask 402 and the lettuce positions and sizes. The lettuce size statistics 405 comprise the average vegetable size for vegetables in each cell as well as the corresponding standard deviation. The average sizes are outputted in the form of a two-dimensional colour coded grid 407 in which the shade, colour or depth of colour of each cell represents the lettuce size in the cell.

An example of a grid applied to an image of a desired area including lettuce positions and sizes is shown in FIG. 5.

In this way, a user is presented with a clear and simple representation of which areas of the field have vegetables falling in different average size categories, such as: (a) ready for harvesting; (b) on course for harvesting on a particular date; (c) in need of fertilizer; and (d) too small to reach maturity in time for market. More or fewer categories are possible.

For example, the depth of colour may decrease with lettuce size. For example, a larger average size in a cell is represented by a deeper colour and a smaller size by a lighter colour. In this context, depth of colour is intended to include depth of grey scale.

As another example, category (a) can be deep green, category (b) medium green and category (c) light green. Category (d) can be very light green or a different colour such as brown or red.

From such a map, a user can readily deploy pickers to pick those in category (a) or apply fertilizer to those in category (c) only. Fertilizer is not wasted on produce in categories (a), (b) and (d), thus saving on cost and reducing phosphate and nitrate pollution.

The output of the application layer process 406, the colour-coded grid 407 and the total number of lettuces are used to produce a final output through the output layer 408.

This output may inform a user of not only the number of lettuces in a field and their respective sizes, but also the average size of the lettuces within each cell of the grid.

Referring now to FIG. 5, an example of an image overlaid with a gridded lettuce mask 500 is shown. The image 500 comprises an image of an area 501, which may cover part of a field, a field, or multiple fields. A grid 502 may be applied to the image of the area 501, which splits the image 501 into cells 503. As already mentioned, the dimensions of each cell 503 and hence the area covered by each cell 503 may be set by the user. The cells 503 in FIG. 5 are shown as being square, but may be hexagonal, rectangular, or another shape.

The image of an area may 501 may also comprise lettuce masks 504. The lettuce masks 504 may be outputted by the Mask R-CNN algorithm described in FIG. 2 and may show the shapes of each lettuce in the image 501. Each lettuce mask 504 may also display the size of the lettuce to which it relates. As mentioned in relation to FIG. 4, the average size of lettuces in each cell may be calculated and displayed.

As has been discussed, each cell can be coloured to represent the average size of the lettuces within. Cells with lettuces of a large average size may be darker than cells with lettuces of a smaller average size, as is shown by the shading in FIG. 5.

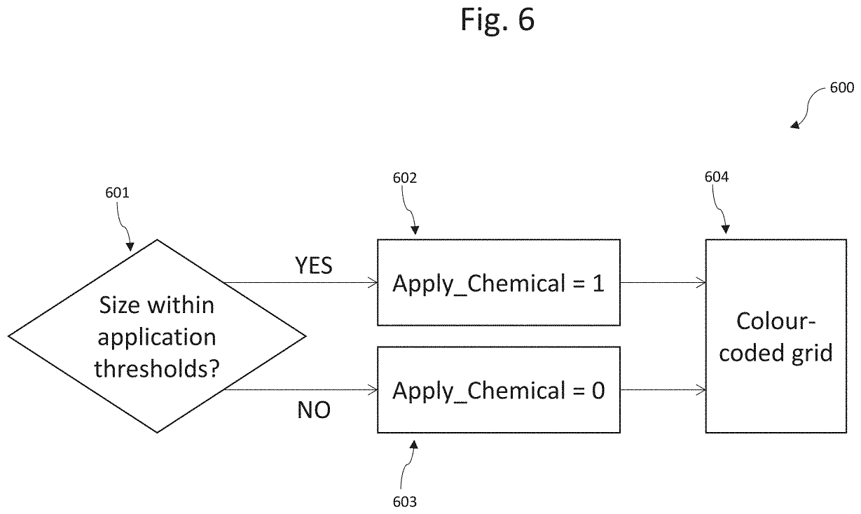

Referring now to FIG. 6, a process 600 that takes place in the application layer 406 is shown. The process 600 may be used to generate a map showing where a particular chemical should be applied. A user may only wish to apply chemicals to areas with lettuces of a certain size. The process may use the lettuce size statistics 405 as an input.

At step 601, it is determined, for a particular cell, whether the average size of the lettuces in that cell is within application thresholds. If the answer is yes, the process moves to step 602, where an Apply_Chemical parameter is set to 1. If the answer is no, the process moves to step 603, where the Apply_Chemical parameter is set to 0. This is performed for every cell. At step 604, a colour-coded grid is outputted. This colour-coded grid displays the cells for which the Apply_Chemical parameter is 1 as one colour and the areas for which the Apply_Chemical parameter is 0 as a different colour (or no colour). The resulting grid therefore shows the user which areas of the field require a particular chemical to be applied and may form part of the final output produced by the output layer 408 in FIG. 4.

The thresholds may be set by a user. For example, a user may determine that cells with lettuces below a certain size may need a chemical to be applied in order to encourage growth. These cells may then be coloured.

Alternatively, a user may determine that cells with lettuces above a certain size may need a chemical to be applied in order to inhibit any further growth. These cells may then be coloured instead.

Alternatively, a user may use two thresholds and determine that cells with lettuces that are neither too large nor too small may need a chemical to be applied. For example, the chemical may be Nitrogen and may not need to be applied to large, well-established lettuces. Nitrogen may also not need to be applied to lettuces that are too small because they may have been poorly established and may not be harvested at the end of the season. In this case, cells for which the average size is neither in the bottom 25% nor the top 25% (i.e. the middle 50%) may have Nitrogen applied to them.

In this way, a user can set their desired thresholds and, from the output, may be able to determine where in the field a certain chemical should be applied.

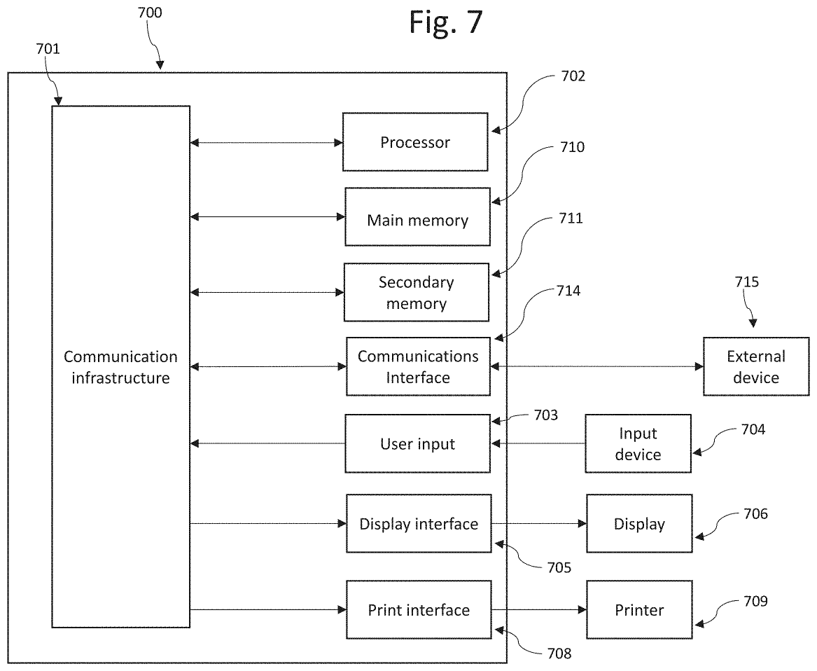

Referring now to FIG. 7, an example computer system 700 is shown in which the present invention, or portions thereof, can be implemented as computer-readable code to program processing components of the computer system 700. Various embodiments of the invention are described in terms of this example computer system 700. For example, computer implemented program 100 of FIG. 1 can each be implemented in such a system 700. The methods illustrated by the flowcharts of FIGS. 2, 3, 4 and 6 can also be implemented in such a system 700. After reading this description, it will become apparent to a person skilled in the relevant art how to implement the invention using other computer systems and/or computer architectures. At least one input to the computer system 700 must be an aerial image.

Computer system 700 includes one or more processors, such as processor 702. Processor 702 can be a special purpose or a general-purpose processor. Processor 702 is connected to a communication infrastructure 701 (for example, a bus, or network). Computer system 700 also includes a user input interface 703 connected to one or more input devices 704 and a display interface 705 connected to one or more displays 706, which may be integrated input and display components. Input devices 704 may include, for example, a pointing device such as a mouse or touchpad, a keyboard, a touchscreen such as a resistive or capacitive touchscreen, etc. A computer display 707 (not shown in FIG. 7), in conjunction with display interface 705, can be used as display 110 shown in FIG. 1 and can display the results 500 shown in FIG. 5. Alternatively, the results 500 can be printed on paper using printer 709 through printer interface 708.

Computer system 700 also includes a main memory 710, preferably random access memory (RAM), and may also include a secondary memory 711. Secondary memory 711 may include, for example, a hard disk drive 712 (not shown in FIG. 7), a removable storage drive 713 (not shown in FIG. 7), flash memory, a memory stick, and/or any similar non-volatile storage mechanism or cloud memory. Either or both of main memory 710 and secondary memory 711 may include means for allowing computer programs or other instructions to be loaded into computer system 700. Examples of such means may include a program cartridge and cartridge interface (such as that found in video game devices), a removable memory chip (such as an EPROM, or PROM) or the like.

Computer system 700 may also include a communications interface 714. Communications interface 714 allows software and data to be transferred between computer system 700 and external devices 715. Communications interface 714 may include a modem, a network interface (such as an Ethernet card), a communications port, a PCMCIA slot and card, or the like.

Various aspects of the present invention can be implemented by software and/or firmware (also called computer programs, instructions or computer control logic) to program programmable hardware, or hardware including special-purpose hardwired circuits such as application-specific integrated circuits (ASICs), programmable logic devices (PLDs), field-programmable gate arrays (FPGAs), etc. of the computer system 700, or a combination thereof. Computer programs for use in implementing the techniques introduced here may be stored on a machine-readable storage medium and may be executed by one or more general-purpose or special-purpose programmable microprocessors.

Computer programs, model parameters and model training data for a trained model are stored in main memory 710 and/or secondary memory 711. It will also be appreciated that the model stored in these memories can be trained (and fixed) or adaptive (and susceptible to further training) Computer programs may also be received via communications interface 714. Such computer programs, when executed, enable computer system 700 to implement the present invention as described herein. In particular, the computer programs, when executed, enable processor 702 to implement the processes of the present invention, such as the steps in the methods illustrated by the flowcharts of FIGS. 2, 3, 4 and 6, and the system component architectures of FIG. 1 described above. Accordingly, such computer programs represent controllers of the computer system 700. Where the invention is implemented using software, the software may be stored in a computer program product and loaded into computer system 700 using removable storage drive 713, interface 703, hard drive 712, or communications interface 714.

Embodiments of the invention employ any computer usable or readable medium, known now or in the future. Examples of computer usable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nano-technological storage device, etc.), and communication mediums (e.g., wired and wireless communications networks, local area networks, wide area networks, intranets, etc.).

It will be understood that embodiments of the present invention are described herein by way of example only, and that various changes and modifications may be made without departing from the scope of the invention.

References in this specification to “one embodiment” are not necessarily all referring to the same embodiment, nor are separate or alternative embodiments mutually exclusive of other embodiments. In particular, it will be appreciated that aspects of the above described embodiments can be combined to form further embodiments. For example, alternative embodiments may comprise one or more of the training data generator, training module and trained Mask CNN described in the above embodiments. Similarly, various features are described which may be exhibited by some embodiments and not by others. Yet further alternative embodiments may be envisaged, which nevertheless fall within the scope of the following claims.

1. A plants analysis apparatus for computer analysis of plants in an area of interest, comprising:
an input device for receiving at least one aerial image of the area of interest;
an object-mask-predicting region-based convolutional neural network, Mask R-CNN, for performing object detection, wherein the Mask R-CNN is trained to detect a selected vegetable and to determine numbers and sizes of objects detected.

2. The apparatus of claim 1, further comprising:
a mapping module for dividing the area of interest into multiple cells and calculating, for each cell, an average size of objects in that cell; and
an output device for displaying results in the form of a map of the area of interest with at least one of colour and scale for each cell corresponding to the average size of objects in that cell.

3. The apparatus of claim 2, wherein the output device shows which cells have vegetables falling in different average size categories.

4. The apparatus of claim 2, wherein the map has a depth of colour or grayscale that progresses with vegetable size.

5. A method for computer analysis of plants in an area of interest, comprising:
providing, from a camera, at least one aerial image of the area of interest;
performing object detection using a computer adapted to perform as an object-mask-predicting region-based convolutional neural network, Mask R-CNN, wherein the Mask R-CNN is trained to detect a selected vegetable;
determining, using the computer adapted to perform as a Mask R-CNN, numbers and sizes of objects detected.

6. The method of claim 5, further comprising dividing, by a mapping module, the area of interest into multiple cells.

7. The method of claim 6, further comprising calculating, by the mapping module, for each cell, an average size of objects in that cell; and
displaying results in the form of a map of the area of interest with at least one of colour and scale for each cell corresponding to the average size of objects in the cell.

8. The method of claim 5, wherein the performing object detection comprises performing segmentation using a pixel-level binary classification.

9. The method of claim 5, wherein the performing object detection comprises:
generating feature maps, each feature map having a shape, the shape being a width in pixels of the feature map;
providing predetermined anchor boxes, each pre-configured according to a corresponding feature map and each anchor box having a base width linked to the shape of its associated feature map; and
applying a ratio to each anchor box to generate non-squared anchor boxes;
wherein the anchor boxes are generated at each pixel of each feature map.

10. The method of claim 9, wherein the anchor boxes are separated by a specific stride, the stride being a number of pixels that equates to a downscaling factor for the at least one aerial image.

11. The method of claim 9, wherein the performing object detection further comprises:
comparing the anchor boxes with ground truth bounding boxes;
determining an extent to which each anchor box matches with a ground truth bounding box; and
selecting anchor boxes that match the most with the ground truth bounding boxes.

12. The method of claim 11, wherein determining the extent to which each anchor box matches with a ground truth bounding box comprises calculating an Intersection over Union, IoU, value, wherein:
if the IoU value is lower than a first threshold the anchor is classified as negative;
if the IoU value is between the first threshold and a second threshold the anchor is classed as neutral; and
if the IoU value is greater than the second threshold the anchor is classed as positive.

13. The method of claim 12, wherein a number of ground truth instances per image kept to train a region proposal network, RPN, is less than a third threshold.

14. The method of claim 11, further comprising carrying out a polygonal Non-Maximum Suppression, PNMS, algorithm to remove selected anchor boxes overlapping with each other.

15. The method of claim 5, wherein different model parameters are fed into the Mask R-CNN depending on the type of selected vegetable.

16. The method of claim 5, wherein the Mask R-CNN comprises a detection layer that outputs regions of interest, ROIs.

17. The method of claim 5, wherein the Mask R-CNN outputs pixel-level masks for each vegetable in the area of interest.

18. The method of claim 5, wherein the at least one aerial image undergoes an orthomosaicking procedure performed by an orthomosaicking module, the orthomosaicking procedure comprising:
determining, for a specific field, a percentage of the field that is covered by the at least one aerial image; and
proceeding only if the percentage of the field covered by the at least one aerial image is above a threshold.

19. A method for computer analysis of plants in an area of interest, comprising:
providing, from a camera, at least one aerial image of the area of interest;
performing object detection using a computer adapted to perform as an object-mask-predicting region-based convolutional neural network, Mask R-CNN, wherein the Mask R-CNN is trained to detect a selected vegetable;
determining, using the computer adapted to perform as a Mask R-CNN, numbers and sizes of objects detected; and
dividing, by a mapping module the area of interest into multiple cells.
displaying, by a display module, results in the form of a map of the area of interest with at least one of colour and scale for each cell corresponding to an average size of objects in that cell, wherein the map shows which cells have vegetables falling in different average size categories.

20. The method of claim 19, wherein the map has a depth of colour or grayscale that progresses with vegetable size.

21. The method of claim 19, further comprising stitching together vegetable masks outputted by the Mask R-CNN algorithm.

22. The method of claim 19, further comprising:
determining whether the average size of the object in each cell is within a threshold; and
additionally colouring the map to show which cells have objects whose average size is within the threshold.

23. The method of claim 19, wherein each cell represents an area of 2×2 metres.
